(19) United States
(12) Patent Application Publication
(10) Pub. No.: US 2014/0120502 A1
(43) Pub. Date: May 1, 2014

(54) LANGUAGE LEARNING USING ELECTRONIC BOOK

(71) Applicant: Clayton Prince, Philadelphia, PA (US)

(72) Inventor: Clayton Prince, Philadelphia, PA (US)

(21) Appl. No.: 13/666,030

(22) Filed: Nov. 1, 2012

(51) Int. Cl. G09B 19/06

(52) U.S. Cl. CPC G09B 19/06
USPC 434/157

(57) ABSTRACT

A language learning method utilizing an interactive electronic book. The interactive book may display two identical pages, one page displaying text in the user's native language and the corresponding page displaying the appropriate translation in the target language. Selection of native-language text results in hearing the material as it normally or casually spoken in the target language. Illustrations may supplement the text and reinforce understanding of the depicted actions.

### FEDERALLY SPONSORED RESEARCH

Not Applicable

### SEQUENCE LISTING OR PROGRAM

Not Applicable

### BACKGROUND 1. Field

This application relates to language learning, specifically to a self-study method and apparatus utilizing interactive electronic books.

2. Prior Art

In an ever-expanding global economy it has become more pertinent than ever to acquire a new language and increase the ease of cross-global lingual communication. There have been many self-study methods of language learning produced and made available to the public. Many of these methods utilize little more than a direct translation and pronunciation guide. This is an ineffective methods since the user has little guidance in local colloquial pronunciations or regional dialects. Even if the users can ask questions of native speakers, they may be unable to grasp the answers provided since they may have difficulty keeping up with the pace of a native speaker.

Methods that utilize books with text altered for self-learning are typically just provided with a translation list located in the back of the book. This disrupts the reading process and does not provide a sentence form translation for the learner to easily understand. For example, U.S. Pat. No. 5,178,542 presents a solution to the need to flip from the front of the book to back to look for translations; it accomplishes this with a transparent overlay on top of a comic book page that contains full phrase translation of the original text. However, this does not present a suitable method for the learner to properly understand pronunciation of words in a desired new foreign language. If a learner is only able to read the foreign words with no audio aid, the learner's native accent and native grammar may mask the actual pronunciation of the foreign words. Another issue that typically arises with many language learning programs is that the instructional material is not entertaining enough to engage the learner's interest and may be tedious and time-consuming.

An effective language learning method must possess the ability to hold the learners interest, have a correct translation immediately available with correct pronunciation and colloquial accent, and clearly demarcate new words.

Another prior-art scheme is presented in U.S. Pat. No. 6,438,515. Written sentences in the language under study are presented, and beneath them are translations into the learner's primary language. This method focuses on breaking down the sentences into smaller “chunks of meaning”. While this method helps the learner to quickly see what words may mean without having to go back and forth with a dictionary, it does not help the with learning conversational phrases, nor with proper syntactical methods of composing sentences. The method described is very good for being able to ascertain the translation of words and some short phrases but provides no help whatsoever with the pronunciation of the translated words and phrases, nor with the syntax and cadence of the target language.

Another prior-art scheme is presented in U.S. Pat. No. 7,257,366. This method is primarily intended for young children, and presents the primary and target languages with equal emphasis. It focuses on presenting singular words with an illustration for example presenting the word “house” (for example) along with a picture of a house and then the translated word in the target language would be presented as well. This method is not good at teaching full sentence structure. It presents a word with its direct translation.

### SUMMARY OF THE INVENTION

A present invention provides a scheme for learning a foreign language utilizing an interactive electronic book. The interactive book may display two identical facing pages, one page displaying text in the user's native language and the corresponding page displaying the appropriate translation in the target language (the language that the user is trying to learn). There are means to click on the text to hear the material as it is normally or casually spoken by a native speaker of the target language. As the text is being heard it is highlighted on the screen, word by word. The words and sentences may be spoken by a native speaker of the desired language, so that the learner may subconsciously begin to emulate or understand the words, sounds, accent, and cadence. The pages may display text in conjunction with related illustrations; the illustrations would supplement the text and provide an understanding of the depicted actions. The learner may proceed learning at his/her own pace. The learner may use multiple repetitions of listening to the text to reinforce the words. The ability to hear the words as they are naturally spoken helps acclimate the learner to the natural accent and cadence of the target language.

### BRIEF DESCRIPTION OF DRAWINGS

The drawings exemplify the current envisioned embodiment of the language learning method, which may be embodied in various forms.

FIG. 1 illustrates a sample shot of a electronic display screen with two pages of a graphic novel, one page containing text in English and the parallel identical page containing the text translated into Spanish

FIG. 2 illustrates a sample shot of a electronic display screen with two pages of a children's story, one page containing text in English and the facing page identical except for containing the text translated into Spanish.

### DETAILIED DESCRIPTION

The following detailed description is of a currently contemplated mode of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention generally provides a language learning method using an electronic book.

Seeing pictures while looking at and hearing the words spoken by a native speaker may allow a learner to learn a new language more effectively. The learner may proceed learning at his/her own pace. As long as a story holds the learner's attention, the learner will want to read on, and follow along.

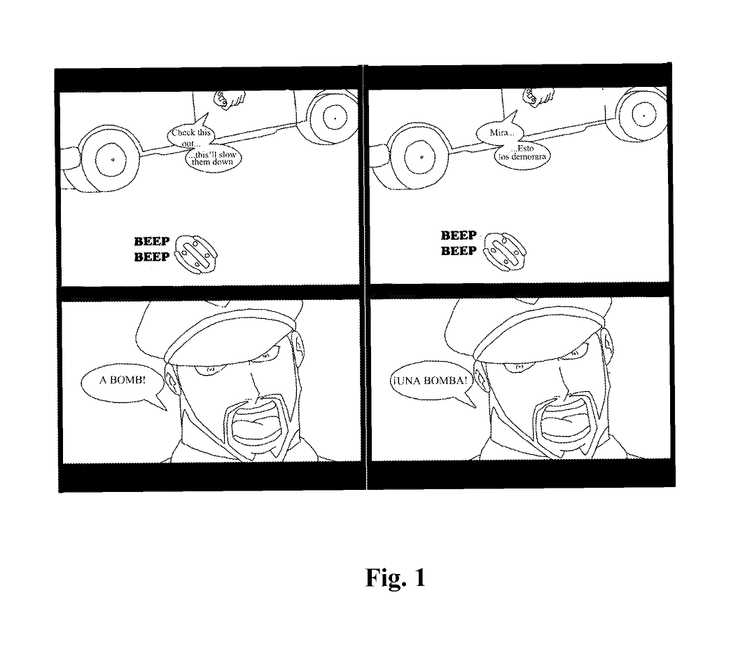

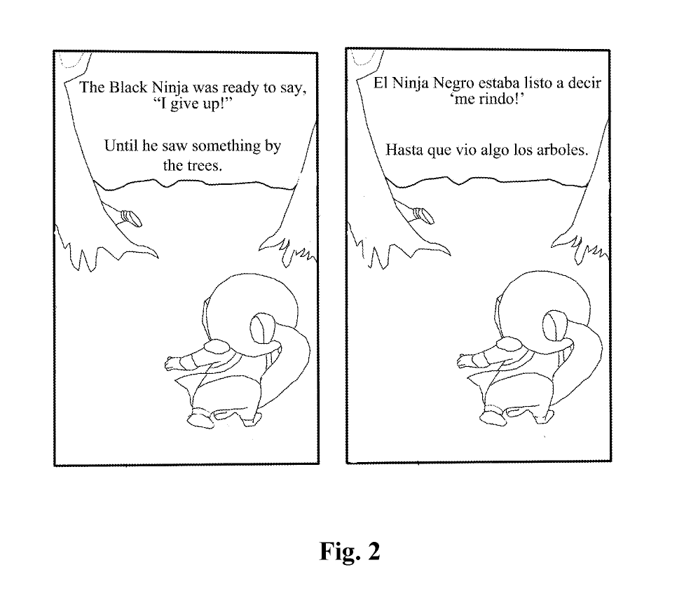

Referring now to FIG. 1 and FIG. 2, display contents of an electronic book of the language learning method are shown according to exemplary embodiments of the present invention. The display may include two identical comic book pages, one page using text in learner's currently spoken language and the other page using translated text in the target language the learner is trying to learn. The book pages may include illustrations depicting some action; text 14.a, text 14.b, text 15.a, and text 15.b, associated with the scope and material of the text.

In a preferred embodiment, an electronic book is presented on a device such as a personal computer (PC), smart phone, or tablet equipped with a viewing screen, a keyboard or keypad for entering commands, and a pointing device (such as a “mouse”) for interacting with displays on the viewing screen; the learner may “click” the mouse to command interaction with an object presently designated by the pointing device. The learner may interact with the electronic book by clicking on the text 14.a and 15.a to hear it spoken in learner's native language. Then the learner may click on text 14.b and 15.b to hear the appropriately translated text in the target language by a native speaker thereof. As the text is heard spoken one envisioned embodiment may have the text highlighted or in a different color so as to emphasize the words as they are heard; another envisioned embodiment may have a black bar underline each word of the text as it is heard by the learner. The use of a native speaker with the translated spoken text may cause the learner to subconsciously begin to emulate or understand the sounds and the words and the cadence as they are normally or casually pronounced and used in the target language.

The present scheme presents full sentence translation. This helps the user to learn to speak conversationally and to develop proper sentence syntax, grammar, and cadence. And, an interactive component allows the text to be heard spoken, preferably by a native speaker. Hearing it spoken by a native speaker helps the user pick up correct pronunciation of the words and develop an ear for hearing native speakers talking at a natural pace and in the cadence customary to the target language, whereas the prior-art methods present the words and phrases in a slowed down manner and teach the words and phrases very slowly. This makes it harder for the user to understand someone speaking at a regular pace. The preferred embodiment also emphasizes presenting illustrations along with the text to help the user understand the action being described. Any language learning system takes time dedication; however if the learning material is not engaging then it does not provide enough to continually make the user want to press forward. The present embodiment relies on using illustrated books with continuing story lines and that would motivate the user to continue reading and learning and expand their base of vocabulary.

The learner may spend as much time on a page as desired, and then move on to follow along with the story by clicking on a control icon (not shown). The use of various exciting stories may keep the learner's attention and may stimulate his/her interest. It may not matter what order the text on the page is clicked as long as the learner clicks on the same text 14.a and b or 15.a and b in both languages and thus, the meanings of the words become apparent.

The present scheme also presents both languages with equal focus but it does it in full sentence form. This helps the user to become accustomed to appropriate responses and correct phrasing and grammar. The preferred embodiment uses selected stories and characters that are appropriate to the particular age group and gender of the learner to promote the user' interest in wanting to see what happens next in the story and to see their favorite characters continue on in other stories. Although the prior art envisions use of an electronic book. The word-by-word (as opposed to full-sentence) translations teach only limited aspects of the target language.

The above described actions may continue with multiple repetitions. The repetition may be the key to the language learning method's success. Presenting language study material visually and aurally by an electronic book may provide the learner optimum chances to learn a new language.

The language learning method may be best performed with specially prepared study units. Such study materials are currently envisioned to be operated on a preferred embodiment of a personal computer, or mobile phone with application capabilities, or a portable electronic tablet.

It should be understood, of course, that the foregoing relates to exemplary embodiments of the invention and that modifications may be made without departing from the spirit and scope of the invention as set forth in the following claims.

What is claimed is:

1. A method of teaching a target language to a person conversant with a primary language, comprising:
presenting in a first portion of a display on an electronic device at least one sentence of text in the primary language;
presenting in a second portion of the display the translation of the text in the target language;
allowing the user to select sentences of text in either portion;
and
playing on the electronic device a recording of a selected sentence in the target language spoken by a person proficient in the target language.

2. The method of claim 1 wherein further:
the displayed text is accompanied by images illustrative thereof.

3. The method of claim 1 wherein further:
as each word is being sounded in the recording the displayed text of that word is visually identified.

4. The method of claim 3 wherein further:
visually identifying a word is accomplished by altering a display property of the word.

5. Apparatus for teaching a target language to a person proficient in a primary language, comprising:
an electronic device with means for storing and displaying representations of text and means for storing and playing representations of sound;
the storing means containing at least one article comprising written text in both the primary and target languages and corresponding spoken text in the target language;
means for accepting from the person selection of an article,
means for displaying in a first portion of the display means at least one sentence from the selected article in the primary language, and
means for displaying in a second portion of the display means the corresponding sentence in the target language;
means for accepting from the person selection of a displayed sentence in either portion of the display and playing as sound the selected sentence spoken in the target language by a person proficient therein.

6. The apparatus of claim 5 wherein further:
the electronic device is further adapted to store and display representations of images;
the stored article contains images illustrative of the stored text;
and
the display means displays an image illustrative of the displayed sentence.

7. The apparatus of claim 5 wherein further:
as each word of sound recording is playing its corresponding displayed text representation is visually identified.

8. The apparatus of claim 7 wherein further:
visual identification of a word is accomplished by altering a display property of the word.
